(19) United States
(12) Patent Application Publication
(10) Pub. No.: US 2023/0026601 A1
(43) Pub. Date: Jan. 26, 2023

(54) CONTACTLESS GATE POSITION SENSOR AND METHOD

(71) Applicants: Maeve Garigan, San Marcos, TX (US); Jason Duncan, Harrison, OH (US); Brett Huizinga, Cedar Rapids, IA (US); Alexander Mazany, Dallas, TX (US); Jonathan Wampler, Seattle, WA (US)

(72) Inventors: Maeve Garigan, San Marcos, TX (US); Jason Duncan, Harrison, OH (US); Brett Huizinga, Cedar Rapids, IA (US); Alexander Mazany, Dallas, TX (US); Jonathan Wampler, Seattle, WA (US)

(21) Appl. No.: 17/385,867

(22) Filed: Jul. 26, 2021

(51) Int. Cl. G01S 17/46; A01K 1/00; A01K 29/00; G01S 17/88

(52) U.S. Cl. CPC G01S 17/46; A01K 1/0017; A01K 29/00; G01S 17/88

(57) ABSTRACT

A contactless gate position sensor includes an optical time-of-flight sensor positioned within a predetermined proximity of a gate for detecting a closed position of the gate and an open position of the gate. The optical time-of-flight sensor has a predetermined field of view. When a predetermined portion of the gate is within the predetermined field of view, a status of the gate is set to a closed status. When the predetermined portion of the gate is outside the predetermined field of view, the status of the gate is set to an open status. The status is detected by the optical time-of-flight sensor and transmitted using a data communication network.

### TECHNICAL FIELD

The present disclosure relates to barriers or enclosures, such as fences, including gates for ingress and egress. More specifically, the present disclosure is directed to a contactless gate position sensor for determining the position of a gate relative to the fence.

### BACKGROUND

There are approximately 54 million adult beef cattle in the United States and most of these animals are born and raised in outdoor environments, such as pastures, rangelands and forests, making them vulnerable to predation, theft, injury and disease. Providing and maintaining safe and effective fencing is of major importance to cattle production and many other outdoor industries, for avoiding costly losses and even legal issues.

### SUMMARY

According to one aspect, a contactless gate position sensor includes an optical time-of-flight sensor positioned within a predetermined proximity of a gate for detecting a closed position of the gate and an open position of the gate. The optical time-of-flight sensor has a predetermined field of view that is established, within sensor design limitations, via programming. When a predetermined portion of the gate is within the predetermined field of view, a status of the gate is indicated as closed. When the predetermined portion of the gate is outside the predetermined field of view, the status of the gate is indicated as open. The status is detected by the optical time-of-flight sensor and transmitted using a data communication network.

According to another aspect, a method of determining a status of a gate using a contactless gate position sensor includes a step of positioning an optical time-of-flight sensor within a predetermined proximity of the gate for detecting a closed position of the gate and an open position of the gate. A field of view of the optical time-of-flight sensor is defined, and a status of the gate is identified as closed when a predetermined portion of the gate is within the predetermined field of view. The status of the gate is identified as open when the predetermined portion of the gate is outside the predetermined field of view. Thus, this method can determine gate status without regard to gate structure, gate material or attachment method; allows the gate to move within its retention without registering as “open;” and can be fully enclosed and protected from dust, moisture, and weather. This method also includes transmitting the status of the gate using a data communication network.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates portions of a fence, including a gate, positioned and configured for containment of cattle, according to an exemplary embodiment of the present disclosure;

FIG. 2 is a simplified diagram of the concept behind an optical time-of-flight sensor, illustrating an aspect of the present disclosure;

FIG. 3 is a simplified diagram illustrating usage of an optical time-of-flight sensor, according to another aspect of the present disclosure;

FIG. 4 is another simplified diagram illustrating usage of an optical time-of-flight sensor, according to another aspect of the present disclosure;

FIG. 5 is a perspective view of the contactless gate position sensor system, including an optical time-of-flight sensor, microcontroller and radio communications portion, and a power management portion.

FIG. 6 illustrates a system architecture in which the optical time-of-flight sensor of the present disclosure may be integrated.

FIG. 7A-7D is a schematic illustration of the circuit diagram for one embodiment of the optical time-of-flight sensor system.

Like reference numbers and designations in the various drawings indicate like element.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting. It should also be clear that implementations and/or embodiments may evolve over time, and still remain within the spirit and scope of the invention.

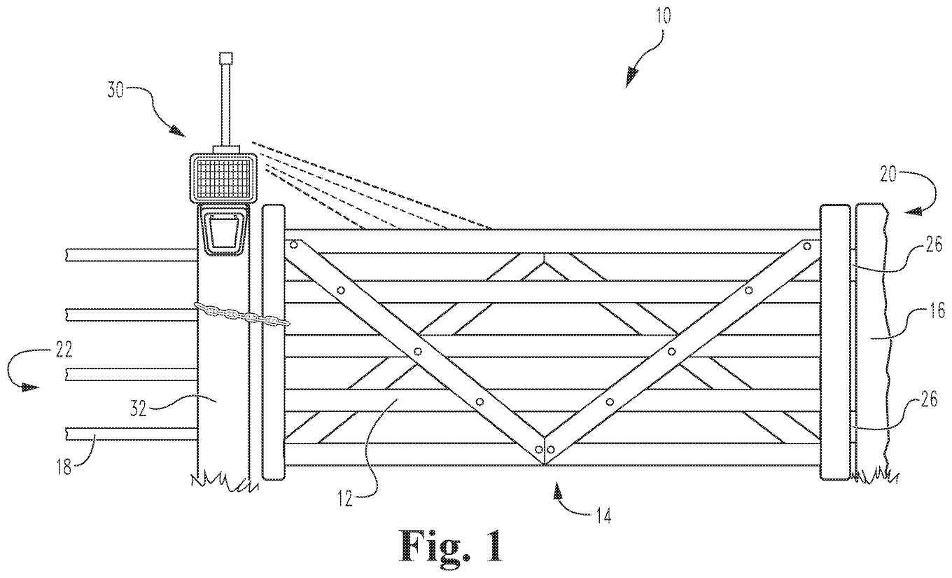

FIG. 1 is a section of fencing 10 that may be used, according to the exemplary embodiment described herein. More specifically, for example, the present disclosure is applicable to improving the containment of cattle and other animals, as described herein. The section of fencing 10 depicted may include a gate 12 supported within a space 14 between a first fence length 16 and a second fence length 18. The gate 12 and the first and second fence lengths 16 and 18 may form a barrier between an inner area 20 and an outer area 22. According to some embodiments, multiple fence lengths, including fence lengths 20 and 22, and the gate 12 are contiguous and form a complete enclosure of the inner area 20 or, at least a separation between the inner area 20 and the outer area 22.

The gate 12 may have a first end 24 pivotally mounted to the first fence length 16 via a hinge 26, for example, and a second end 28 that swings freely relative to the second fence length 18. Hinges 26 or other similar fastening devices may be used to both permit and restrict the relative movement between the second end 28 of the gate 12 and the second fence length 18. For example, some devices permit a range of pivotal movement of the gate 12, even while the gate 12 is considered “closed,” while other devices may strictly limit or restrict pivotal movement of the gate 12. Various types and configurations of fencing, including gates, gate and fencing hardware, and the like, made from various materials, may benefit from the teachings of the present disclosure.

According to the present disclosure, an exemplary contactless gate position sensor may include an optical time-of-flight sensor 30, such as a laser-based sensor, which may be positioned within a predetermined proximity of the gate 12 for detecting a closed position of the gate 12 and an open position of the gate 12. According to some embodiments, a post 32 of the first fence length 16 may support the optical time-of-flight sensor 30.

Distance measurement and object detection play significant roles in numerous areas, including factory automation, robotics applications, consumer electronics and logistics. Especially in the context of safety, detection and response to objects or people at specific distances are required. For example, a robot arm may need to stop immediately once a worker enters its danger zone. And, according to the present disclosure, successful containment of cattle is of utmost importance.

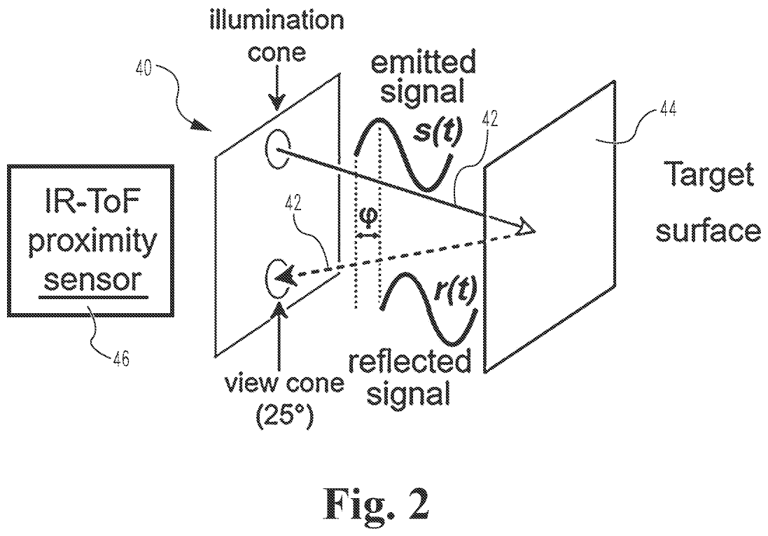

Time-of-flight (ToF) is becoming increasingly important for these purposes. With ToF technology, as illustrated in FIG. 2, light is emitted from a modulated source, such as a laser, at 40, and the light beams 42 reflected off one or more objects, such as a target surface 44, are then captured by a sensor, or camera, 46. The distance can thereby be determined by means of the time delay Δt between when the light is emitted and when the reflected light is received. The time delay is proportional to twice the distance between the camera and the object (round trip). Therefore, the distance can be estimated as the depth d=(c×Δt)/2, where c is the speed of light.

As described with reference to FIG. 1, the gate 12 may have a first end 24 pivotally mounted to the first fence length 16 via a hinge 26, for example, and a second end 28 that swings/pivots freely relative to the second fence length 18. A time-of-flight sensor 30 employs time-of-flight techniques to resolve distance between the sensor 30 and the subject for each point of the image, by measuring the round trip time of an artificial light signal provided by a laser or an LED.

With reference again to FIG. 2, the sensor 30 works to calculate distance by processing the time it takes for its emitted photon signal to return to the device. The on-board laser driver emits the photon signal, and the reflection is received by the sensors Single Photon Avalanche Diode (SPAD) light receiver. The actual internals of this SPAD receiver are slightly complex and breaking it down into greater detail is outside the scope of knowledge needed for this device.

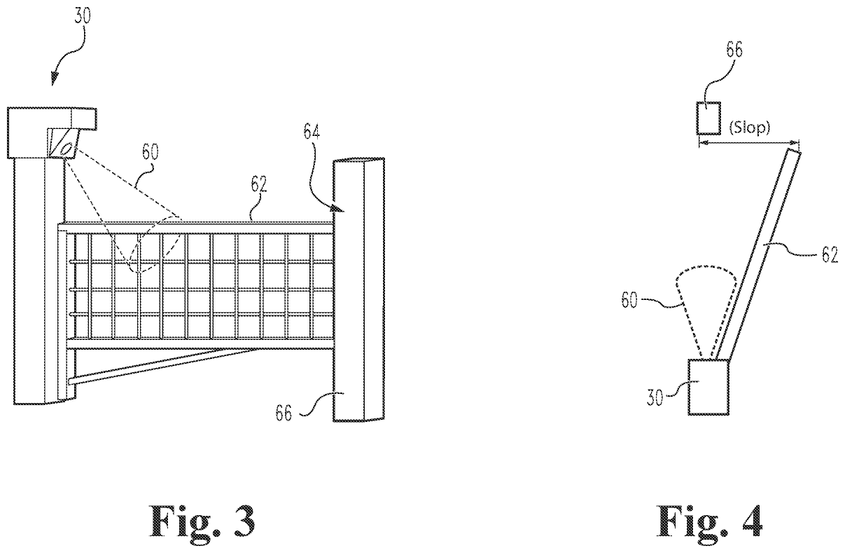

Turning now to FIG. 3, it is important to understand what the SPAD receiver accomplishes as part of an entire system. The sensor 30 facilitates control of the Region of Interest (ROI). The ROI can be thought of as a viewing cone, shown at 60. Parts of the SPAD can be turned on and off to control which parts of the SPAD are being read and thus control the size of the cone 60.

The optical time-of-flight sensor 30, or other sensor, has a predetermined field of view, with the cone 60 defining the predetermined field of view in the exemplary embodiment. When a gate 62, or a particular portion thereof, is within the predetermined field of view, a status, or status identifier, of the gate 62 is set to “closed.” When the gate 62 is outside the predetermined field of view, the status of the gate 62 is set to “open.” The status of the gate 62 is detected by the optical time-of-flight sensor 30 and transmitted using a data communication network.

Similarly, the status of the gate 62 is closed when the second end 64 is positioned within a first predetermined angle range relative to an end of the second fence length 66. The status of the gate 62 is open when the second end 64 is positioned within a second predetermined angle range relative to the end of the second fence length 66, wherein the second predetermined angle range is greater than the first predetermined angle range.

Controlling the ROI from the SPAD is important because it allows for control of “slop” to an optimal amount to meet the desires of a particular application. Slop, as illustrated in FIG. 4, is the amount of distance a gate 62 is allowed to open before the device, or sensor, 30 determines that the gate 62 is open and communicates this status change via data communications. Not all gates use latches to be kept closed and may be retained by a variety of methods, including chains or ropes. This means that gates can swing within the confines of the retention method without being open. To meet the needs of different gate materials and retention methods, there must be a range in gate 62 positions that the sensor 30 would detect as being closed. This permits adaptability to different gates and different applications, including gates and fencing having different materials, such as wood, metal, plastic, and fiber.

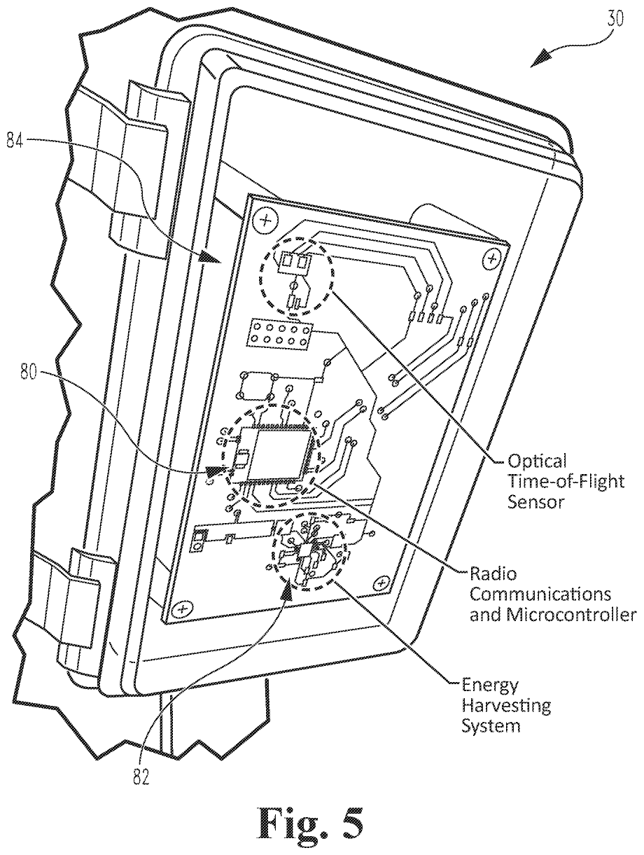

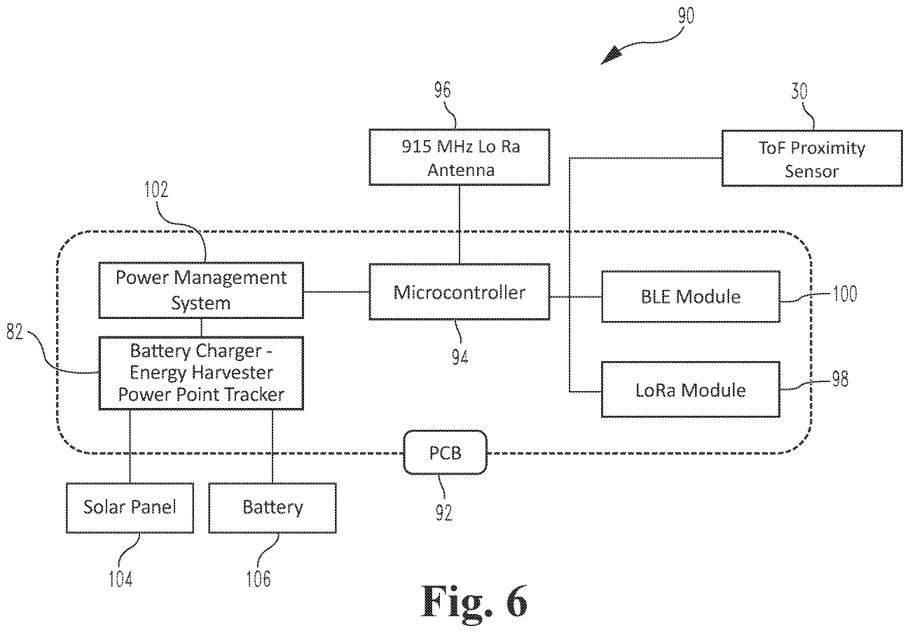

According to an exemplary embodiment, and as shown generally in FIG. 5, the sensor, or sensor system, 30 emits a photon signal and receives photons back that were reflected from the object they made contact with. Then the sensor 30 receives these photons, the device interprets the information it received from them and relays it in inter-integrated circuit (I2C) drivers and software libraries to interpret the I2C data from the sensor 30. The software library uses function calls inside the software package to determine if a gate is opened or closed. If it is determined that the status of the gate is open, this information may be communicated to a particular system or subsystem.

A communications module 80, through which communications may be both sent and received over the long range (“LoRa”) radio standard may also be provided. One particular microcontroller may be a system in package that includes a 32-bit ARM® Cortex microcontroller and SAM R34 LoRa radio module.

The sensor system, or device, is powered by a battery which is connected to the printed circuit board (PCB) populated with sensor system components. Additionally, the device has the capabilities to charge this battery from a solar panel that can be connected to the device and with its output managed by a power management integrated circuit on the PCB, shown at module 82, that integrates a battery charger, energy harvester and power point tracker.

Since the contactless gate position sensor is most likely to be used outdoors, a weatherproof housing and mounting system 84 may protect the sensor from weather, moisture, dust intrusion and/or other adverse conditions.

The contactless gate position sensor may be a node of a mesh network. A mesh network is a local network topology in which the network nodes connect directly, dynamically, and non-hierarchically to each other to route data. This lack of hierarchy and dependency allows for every node to participate in the relay of data packets generated by other nodes, instead of each node having to communicate directly with a base station, gateway or router to gain access to a higher-level network such as the Internet.

All nodes in the mesh network are connected to each other wirelessly. As long as they are within range, they can communicate with one another wirelessly without the need for a router or switch. This allows for fast and efficient data routing.

The sensor may thus function as a node of a mesh network and also transmit sensor information indicating a gate open or gate closed status.

A system 90 may include a PCB 92 that includes a microcontroller 94 packaged with a LoRa radio 98 and with communications via a LoRa antenna 96; and a Bluetooth module with Bluetooth antenna 100 for direct communication with the gate position sensor 30 using a Bluetooth-enabled device, such as a smartphone or tablet, in order to communicate data to or from the Bluetooth-enabled device and the gate position sensor and/or the network. A power management integrated circuit 102 is provided and may manage energy created by the solar panel using the integrated battery charger, energy harvester and power point tracker (82). This communicates with a solar panel 104 and/or battery 106.

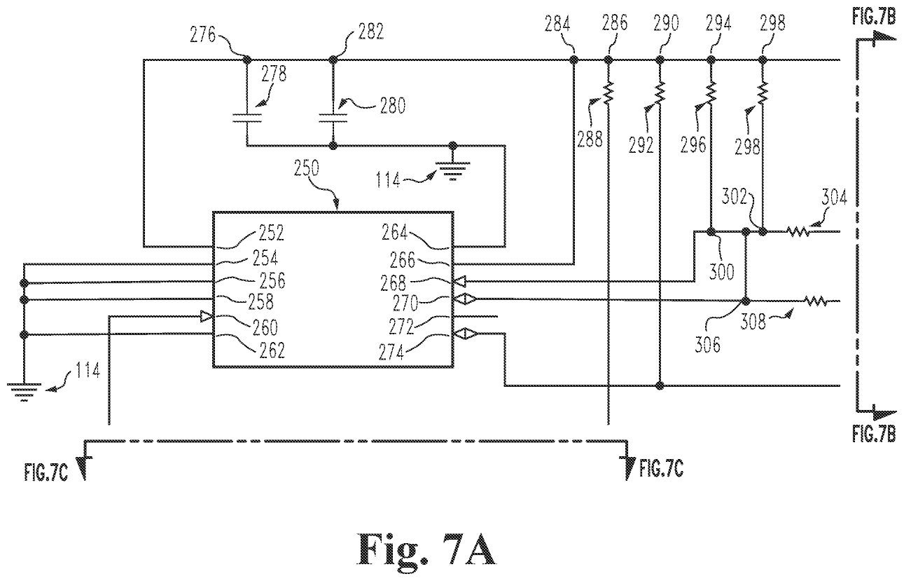

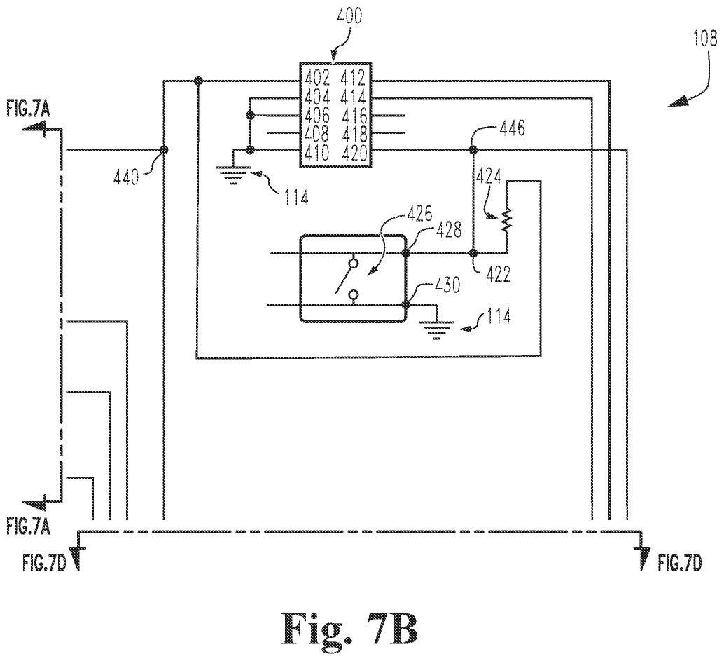

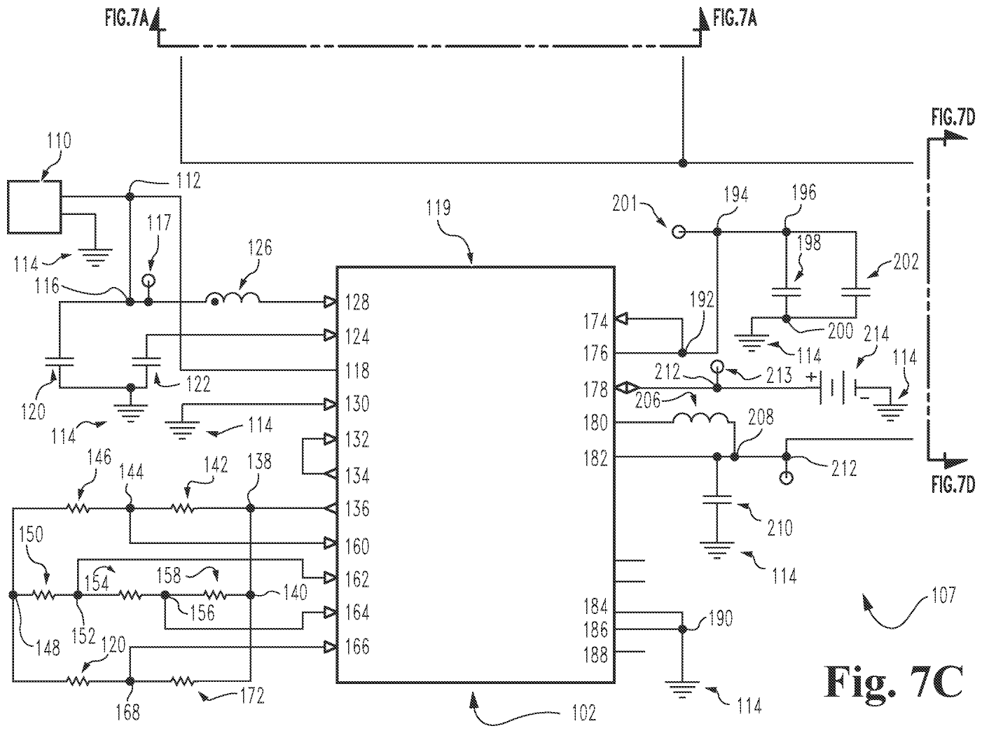

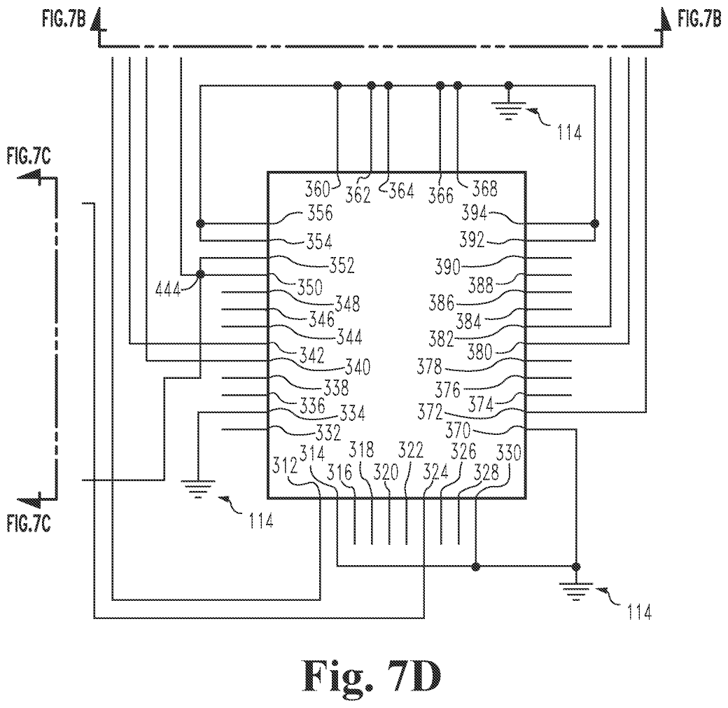

As illustrated in FIG. 7A-D, the system 90 includes a circuit 107 for controlling a contactless gate system, including a power management portion 102, a microcontroller and radio communications portion 98 operationally connected to the power management portion 102, and a switch portion 108 operationally connected to the power management portion 102 and to the microcontroller and radio communications portion 98.

The power management integrated circuit 102 further includes a first connector 110 connected in electric communication with a first node 112 and with ground 114. The first node 112 is electrically connected to a first pin 128 of a power management integrated circuit 119. A second node 116 is connected in electric communication with the first node 112, a first test point 117, and a first capacitor 120. The first capacitor 120 is electrically connected to ground 114. A second capacitor 122 is electrically connected to ground 114. The power management integrated circuit 119 has a second pin 124 connected in electric communication with the second capacitor 122, a third pin 118 connected in electric communication with a first inductor 126, a fourth pin 130 electrically connected to ground 114, fifth and sixth pins 132, 134 electrically connected to each other, and a seventh pin 136 electrically connected to a third node 138. The third node 138 is electrically connected to a fourth node 140 and to a first resistor 142. The first resistor 142 is electrically connected to a fifth node 144. The fifth node 144 is electrically connected to second resistor 146. A sixth node 148 is electrically connected to the second resistor 146 and to a third resistor 150. The third resistor 150 is electrically connected to a seventh node 152. The seventh node 152 is electrically connected to a fourth resistor 154. The fourth resistor 154 is electrically connected to an eighth node 156 and to the fourth node 140. The power management integrated circuit 119 has an eighth pin 160 electrically connected to the fifth node 144, a ninth pin 162 electrically connected to the seventh node 152, a tenth pin 164 electrically connected to the eighth node 156, and an eleventh pin 166 electrically connected to a ninth node 168.

A sixth resistor 170 is electrically connected to the sixth node 148 and to the ninth node 168. A seventh resistor 172 is electrically connected to the ninth node 168 and to the third node 138. The power management integrated circuit 119 has twelfth, thirteenth, fourteenth, fifteenth, sixteenth, seventeenth, eighteenth, and nineteenth pins 174, 176, 178, 180, 182, 184, 186, 188, wherein the seventeenth, eighteenth, and nineteenth pins 184, 186, 188 are connected in electric communication with ground 114 through a tenth node 190. The twelfth pin 174 and thirteenth pin 176 are electrically connected to an eleventh node 192. A twelfth node 194 is electrically connected to the eleventh node 192 and to a thirteenth node 196, and a third capacitor 198 is connected in electric communication with the thirteenth node 196 and a fourteenth node 200. The fourteenth node 200 is electrically connected to ground 114. A fourth capacitor 202 is electrically connected to the fourteenth node 200 and to the thirteenth node 196. A second test point 204 is connected in electric communication with the twelfth node 194. A second inductor 206 is connected in electric communication between the fifteenth pin 180 and a fifteenth node 208. A fifth capacitor 210 is connected in electric communication with the fifteenth node 208 and with ground 114. A third test point 212 is electrically connected to the fifteenth node 208. A fourth test point 213 is electrically connected to the fourteenth pin 178 and to a battery 214. The battery 214 is electrically connected to ground 114.

The communications portion 98 further includes an optical sensor integrated circuit 250 having a twentieth pin 252, a twenty-first pin 254, a twenty-second pin 256, a twenty-third pin 258, a twenty-fourth pin 260, a twenty-fifth pin 262, a twenty-sixth pin 264, a twenty-seventh pin 266, a twenty-eighth pin 268, a twenty-ninth pin 270, a thirtieth pin 272, and a thirty-first pin 274. A sixteenth node 276 is connected in electric communication with the twentieth pin 252, a sixth capacitor 278, and a seventeenth node 282. A seventh capacitor 280 is electrically connected to the seventeenth node 282, and the sixth and seventh capacitors 278, 280 are electrically connected to ground 114. An eighteenth node 284 is electrically connected to the seventeenth node 282 and a nineteenth node 286. The nineteenth node 286 is electrically connected to a twentieth node 290. The twenty-first, twenty-second, twenty-third, twenty-fifth, and twenty-sixth pins 254, 256,258, 262, 264 are connected in electric communication with ground 114. The twenty-seventh 266 pin is electrically connected to the seventeenth node 282. An eighth resistor 288 is electrically connected to the nineteenth node 286. A ninth resistor 292 is electrically connected to the twentieth node 290.

A twenty-first node 294 is electrically connected to the twentieth node 290, to a tenth resistor 296, and to an eleventh resistor 298. A twenty-second node 300 is connected in electric communication with the tenth resistor 296, with the twenty-eighth pin 268, and with a twenty-third node 302. A twelfth resistor 304 is electrically connected to the twenty-third node 302. A twenty-fourth node 306 is electrically connected to the twenty-second node 300, to a thirteenth resistor 308, and to the twenty-ninth pin 270. A twenty-fifth node 310 is electrically connected to the twentieth node 290 and to the thirty-first pin 294.

The LoRa integrated circuit 98 has a thirty-second pin 312, a thirty-third pin 314, a thirty-fourth pin 316, a thirty-fifth pin 318, a thirty-sixth pin 320, a thirty-seventh pin 324, a thirty-eighth pin 326, a thirty-ninth pin 328, a fortieth pin 330, a forty-first pin 332, a forty-second pin 334, a forty-third pin 336, a forty-fourth pin 338, a forty-fifth pin 340, a forty-sixth pin 342, a forty-seventh pin 344, a forty-eighth pin 346, forty-ninth pin 348, a fiftieth pin 350, a fifty-first pin 352, a fifty-second pin 354, a fifty-third pin 356, a fifty-fourth pin 360, fifty-fifth pin 362, a fifty-sixth pin 364, a fifty-seventh pin 366, a fifty-eighth pin 368, a fifty ninth pin 370, a sixtieth pin 372, a sixty-first pin 374, a sixty-second pin 376, a sixty-third pin 378, a sixty-forth pin 380, a sixty-fifth pin 382, a sixty-sixth pin 384, a sixty-seventh pin 386, a sixty-eighth pin 388, a sixty-ninth pin 390, a seventieth pin 392, and a seventy-first pin 394. The thirty-third pin 314, the fortieth pin 330, the forty-second pin 334, the fifty-second pin 354, the fifty-third pin 356, the fifty-fourth pin 360, the fifty-fifth pin 362, the fifty-sixth pin 364, the fifty-seventh pin 366, the fifty-eighth pin 368, the fifty-ninth pin 370, the seventieth pin 392, and the seventy-first pin 394 are electrically connected to ground 114.

The thirty-second pin 312 is electrically connected to the twenty-fifty node 310. The thirty-seventh pin 324 is electrically connected to the nineteenth node 286. The forty-fifth pin 340 is electrically connected to the twelfth resistor 304. The forty-sixth pin 342 is electrically connected to the twenty-fifth node 310.

The switch portion 108 further includes a second connector 400 having a seventy-second pin 402, a seventy-third pin 404, a seventy-fourth pin 406, a seventy-fifth pin 408, a seventy-sixth pin 410, a seventy-seventh pin 412, a seventy-eighth pin 414, a seventy-ninth pin 416, an eightieth pin 418, and an eighty-first pin 420, wherein the seventy-third, seventy-fourth, and seventy-sixth pins 404, 406, 410 are electrically connected to ground 114. A twenty-sixth node 422 is electrically connected to the eighty-first pin 420. A fourteenth resistor 424 is electrically connected to the twenty-sixth node 422. A switch 426 is provided having an eighty-second pin 428 connected in electric communication with the twenty-sixth node 422 and an eighty-third pin 430 electrically connected to ground 114.

A twenty-seventh node 440 is connected in electric communication with a twenty-eighth node 442, twenty-ninth node 444, and the twenty-first node 294. The twenty-eighth node 422 is electrically connected to seventy-second pin 402. Twenty-ninth node 444 is electrically connected to fiftieth pin 350, fifty-first pin 352, and third test point 212. Thirtieth node 446 is connected in electric communication with eighty-first pin 420, twenty-eighth node 422, and sixtieth pin 372.

With reference to the present disclosure, a commercial product might have a smaller PCB than the one depicted in the drawings. Further, placement of the battery and/or other components and features may vary in accordance with a commercial embodiment. These variations, and others, do not narrow the spirit and scope of Applicant's disclosure.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A contactless gate position sensor, comprising:
an optical time-of-flight sensor positioned within a predetermined proximity of a gate for detecting a closed position of the gate and an open position of the gate;
wherein the optical time-of-flight sensor has a predetermined field of view;
when a predetermined portion of the gate is within the predetermined field of view, a status of the gate is indicated as closed;
when the predetermined portion of the gate is outside the predetermined field of view, the status of the gate is indicated as open; and
wherein the status is detected by the optical time-of-flight sensor and transmitted using data communications hardware.

2. The contactless gate position sensor of claim 1, wherein the gate is supported within a space between a first fence length and a second fence length, wherein the gate and the first and second fence lengths form a portion of a barrier between an inner area and an outer area.

3. The contactless gate position sensor of claim 2, wherein the gate has a first end pivotally mounted to the first fence length and a second end that swings freely relative to the second fence length.

4. The contactless gate position sensor of claim 3, wherein the status of the gate is closed when the predetermined portion of the gate is within the predetermined field of view of the contactless gate position sensor.

5. The contactless gate position sensor of claim 4, wherein the status of the gate is open when the predetermined portion of the gate is within the predetermined field of view of the contactless gate position sensor.

6. The contactless gate position sensor of claim 1, wherein the contactless gate position sensor uses a radio for data communication.

7. The contactless gate position sensor of claim 1, wherein the contactless gate position sensor is a node of a mesh network.

8. The contactless gate position sensor of claim 1, wherein the contactless gate position sensor is solar powered.

9. A method of determining a status of a gate using a contactless gate position sensor, comprising:
positioning an optical time-of-flight sensor within a predetermined proximity of a gate for detecting a closed position of the gate and an open position of the gate;
defining a field of view of the optical time-of-flight sensor;
indicating a status of the gate as closed when a predetermined portion of the gate is within the predetermined field of view;
indicating the status of the gate as open when the predetermined portion of the gate is outside the predetermined field of view; and
transmitting the status of the gate using a data communication network.

10. The method of claim 9, further including supporting the gate within a space between a first fence length and a second fence length, wherein the gate and the first and second fence lengths form a portion of a barrier between an inner area and an outer area.

11. The method of claim 10, wherein the gate has a first end pivotally mounted to the first fence length and a second end that swings freely relative to the second fence length.

12. The method of claim 11, wherein the status of the gate is closed when the second end is within the predetermined field of view of the optical time-of-flight sensor.

13. The method of claim 12, wherein the status of the gate is open when the second end is outside of the predetermined field of view of the optical time-of-flight sensor.

14. The method of claim 1, wherein the contactless gate position sensor uses a radio for data communication.

15. The method of claim 9, wherein the contactless gate position sensor is a node of a mesh network.

16. The method of claim 9, further including powering the contactless gate position sensor using solar power.

17. A circuit for controlling a contactless gate system, comprising:
an optical time-of-flight portion;
a power management portion;
a microcontroller/communications portion operationally connected to the power management portion;
and
a switch portion operationally connected to the power management portion and to the microcontroller/communications portion;
wherein the power management portion further comprises:
a first connector connected in electric communication with a first node and with ground;
the first node is electrically connected to a first pin of a power management integrated circuit;
a second node connected in electric communication with the first node, a first test point, and a first capacitor;
the first capacitor is electrically connected to ground;
a second capacitor is electrically connected to ground
the power management integrated circuit has a second pin connected in electric communication with the second capacitor, a third pin connected in electric communication with a first inductor, a fourth pin electrically connected to ground, fifth and sixth pins electrically connected to each other, and a seventh pin electrically connected to a third node;
the third node is electrically connected to a fourth node and to a first resistor;
the first resistor is electrically connected to a fifth node;
the fifth node is electrically connected to second resistor;
a sixth node is electrically connected to the second resistor and to a third resistor;
the third resistor is electrically connected to a seventh node;
the seventh node is electrically connected to a fourth resistor;
the fourth resistor is electrically connected to an eighth node and to the fourth node;
the power management integrated circuit has an eighth pin electrically connected to the fifth node, a ninth pin electrically connected to the seventh node, a tenth pin electrically connected to the eighth node, and an eleventh pin electrically connected to a ninth node,
a sixth resistor is electrically connected to the sixth node and to the ninth node;
a seventh resistor is electrically connected to the ninth node and to the third node;
the power management integrated circuit has twelfth, thirteenth, fourteenth, fifteenth, sixteenth, seventeenth, eighteenth, and nineteenth pins;
the seventeenth, eighteenth, and nineteenth pins are connected in electric communication with ground;
the twelfth pin and thirteenth pin are electrically connected to an eleventh node;
a twelfth node is electrically connected to the eleventh node and to a thirteenth node;
a third capacitor is connected in electric communication with the thirteenth node and a fourteenth node;
the fourteenth node is electrically connected to ground;
a fourth capacitor is electrically connected to the fourteenth node and to the thirteenth node;
a second test point is connected in electric communication with the twelfth node;
a second inductor is connected in electric communication between the fifteenth pin and a fifteenth node;
a fifth capacitor is connected in electric communication with the fifteenth node and with ground;
a third test point is electrically connected to the fifteenth node;
a fourth test point is electrically connected to the fourteenth pin and to a battery; and
the battery is electrically connected to ground;
wherein the microcontroller/communications portion further comprises:
an optical time-of-flight sensor integrated circuit having a twentieth pin, a twenty-first pin, a twenty-second pin, a twenty-third pin, a twenty-fourth pin, a twenty-fifth pin, a twenty-sixth pin, a twenty-seventh pin, a twenty-eighth pin, a twenty-ninth pin, a thirtieth pin, and a thirty-first pin;
a sixteenth node is connected in electric communication with the twentieth pin, a sixth capacitor, and a seventeenth node;
a seventh capacitor is electrically connected to the seventeenth node, and the sixth and seventh capacitor are electrically connected to ground;
an eighteenth node is electrically connected to the seventeenth node and a nineteenth node;
the nineteenth node is electrically connected to a twentieth node;
the twenty-first, twenty-second, twenty-third, twenty-fifth, and twenty-sixth pins are connected in electric communication with ground;
the twenty-seventh pin is electrically connected to the seventeenth node;
an eighth resistor is electrically connected to the nineteenth node;
a ninth resistor is electrically connected to the twentieth node;
a twenty-first node is electrically connected to the twentieth node, to a tenth resistor and to an eleventh resistor;
a twenty-second node is connected in electric communication with the tenth resistor, with the twenty-eighth pin, and with a twenty-third node;
a twelfth resistor is electrically connected to the twenty-third node;
a twenty-fourth node is electrically connected to the twenty-second node, to a thirteenth resistor, and to the twenty-ninth pin;
a twenty-fifth node is electrically connected to the twentieth node and to the thirty-first pin;
a LoRa radio integrated circuit has a thirty-second pin, a thirty-third pin, a thirty-fourth pin, a thirty-fifth pin, a thirty-sixth pin, a thirty-seventh pin, a thirty-eighth pin, a thirty-ninth pin, a fortieth pin, a forty-first pin, a forty-second pin, a forty-third pin, a forty-fourth pin, a forty-fifth pin, a forty-sixth pin, a forty-seventh pin, a forty-eighth pin, forty-ninth pin, a fiftieth pin, a fifty-first pin, a fifty-second pin, a fifty-third pin, a fifty-forth pin, fifty-fifth pin, a fifty-sixth pin, a fifty-seventh pin, a fifty-eighth pin, a fifty ninth pin, a sixtieth pin, a sixty-first pin, a sixty-second pin, a sixty-third pin, a sixty-forth pin, a sixty-fifth pin, a sixty-sixth pin, a sixty-seventh pin, a sixty-eighth pin, a sixty-ninth pin, a seventieth pin, and a seventy-first pin;
the thirty-third pin, the fortieth pin, the forty-second pin, the fifty-second pin, the fifty-third pin, the fifty-fourth pin, the fifty-fifth pin, the fifty-sixth pin, the fifty-seventh pin, the fifty-eighth pin, the fifty-ninth pin, the seventieth pin, and the seventy-first pin are electrically connected to ground;
the thirty-second pin is electrically connected to the twenty-fifty node;
the thirty-seventh pin is electrically connected to the nineteenth node;
the forty-fifth pin is electrically connected to the twelfth resistor;
the forty-sixth pin is electrically connected to the twenty-fifth node; and
wherein the switch portion further comprises:
a second connector having a seventy-second pin, a seventy-third pin, a seventy-fourth pin, a seventy-fifth pin, a seventy-sixth pin, a seventy-seventh pin, a seventy-eighth pin, a seventy-ninth pin, an eightieth pin, and an eighty-first pin, wherein the seventy-third, seventy-fourth, and seventy-sixth pins are electrically connected to ground;
a twenty-sixth node electrically connected to the eighty-first pin;
a fourteenth resistor electrically connected to the twenty-sixth node; and a switch having an eighty-second pin connected in electric communication with the twenty-sixth node and an eighty-third pin electrically connected to ground.
